(19) United States
(12) Patent Application Publication
(10) Pub. No.: US 2026/0078214 A1
(43) Pub. Date: Mar. 19, 2026

(54) CURING AGENT FOR EPOXY RESINS, WHICH CURING AGENT HAS DIPHENOLIC ACID

(71) Applicant: SIKA TECHNOLOGY AG, Baar (CH)

(72) Inventors: Urs BURCKHARDT, Zürich (CH); Edis KASEMI, Zürich (CH); Andreas KRAMER, Zürich (CH); Ursula STADELMANN, Zürich (CH)

(73) Assignee: SIKA TECHNOLOGY AG, Baar (CH)

(21) Appl. No.: 19/106,397

(22) PCT Filed: Oct. 24, 2023
(86) PCT No.: PCT/EP2023/079629

§ 371 Date: Feb. 25, 2025

(30) Foreign Application Priority Data
Nov. 9, 2022 (EP) 22206450.3

(51) Int. Cl. C08G 59/58; C08G 59/42; C08G 59/50; C09D 163/00

(52) U.S. Cl. CPC C08G 59/58; C08G 59/4223; C08G 59/4284; C08G 59/5013; C08G 59/5026; C08G 59/5033; C09D 163/00

(57) ABSTRACT

A curing agent for epoxy resins, the curing agent including: at least one amine, which is liquid at room temperature and has 6 to 15 C atoms and two primary amino groups; at least one diphenolic acid of formula (I); and at least one diluent. The curing agent is very simple to prepare, has low viscosity, and provides coatings which: can be applied at ambient temperatures; have good processability; have surprisingly rapid curing; have a high final hardness; have a qualitatively high-grade surface; and have a surprisingly low tendency towards yellowing.

### TECHNICAL FIELD

The invention relates to curing agents for room temperature-curing epoxy resin compositions, especially for coatings.

### PRIOR ART

Epoxy resin-based room temperature-curing polymer compositions are in widespread use in the construction sector, for example as coatings, adhesives or injection resins. They consist of liquid resin components and curing agent components, which are mixed before application and cure at ambient temperatures to form a material of high strength and stability. But such systems often cure only slowly under cool ambient conditions, for instance in the temperature range from 15 to close to 0° C. and also have a tendency to surface defects such as cloudiness, spots, roughness or tack, which is also referred to as “blushing” and occurs especially in the case of elevated air humidity. Particularly in coating applications where high surface quality and hardness is crucial, these disadvantages are very undesirable and often lead to laborious reworking.

Known curing agents for room temperature-curing epoxy resin coatings are combinations of primary diamines such as, in particular, isophoronediamine and salicylic acid, where these typically additionally contain benzyl alcohol. Such curing agents are very easily producible and enable rapid curing to get high-quality surfaces, although there are also drawbacks. The speed of curing is capable of improvement, especially under cold conditions, the final hardnesses achieved are comparatively low, and there is a considerable tendency to yellowing after curing. Moreover, salicylic acid has recently been classified as toxic to reproduction, which makes it difficult to use.

Diphenolic acid (DPA, 4,4-bis(4-hydroxyphenyl)pentanoic acid) is a room temperature solid bisphenol. The use of diphenolic acid as curing agent is known for thermosetting epoxy resin products, described in U.S. Pat. No. 6,562,482 for example. There has also been description of the use of diphenolic acid as starting material for production of epoxy resins, for example in Progress in Polymer Science 108 (2020) 101287.

### SUMMARY OF THE INVENTION

It is an object of the present invention to provide a curing agent for room temperature-curable epoxy resin compositions which is suitable for coatings employable at ambient temperatures and overcomes the disadvantages of the prior art.

This object is achieved by a curing agent as described in claim 1. The curing agent contains a room temperature liquid amine A1 having 6 to 15 carbon atoms and two primary amino groups, a diphenolic acid, and preferably additionally a thinner such as benzyl alcohol in particular. By comparison with known curing agents comprising salicylic acid, the curing agent of the invention surprisingly enables faster curing, higher final hardnesses and surprisingly low tendency to yellowing. The diphenolic acid acts here as accelerator and is also capable of reducing blushing.

The curing agent of the invention is easily producible and of low viscosity, and enables coatings having good processibility, rapid curing and high final hardness, with a high-quality surface and low tendency to yellowing. In addition, the curing agent of the invention has toxicological advantages and is particularly sustainable, especially when a diphenolic acid based on renewable raw materials is used. The curing agent is particularly suitable for epoxy resin coatings that are processed at ambient temperatures, such as floor coatings in particular.

Further aspects of the invention are the subject of further independent claims. Particularly preferred embodiments of the invention are the subject of the dependent claims.

### WAYS OF EXECUTING THE INVENTION

The invention provides a curing agent for epoxy resins, comprising
at least one room temperature liquid amine A1 having 6 to 15 carbon atoms and two primary amino groups,
at least one diphenolic acid of the formula (I)

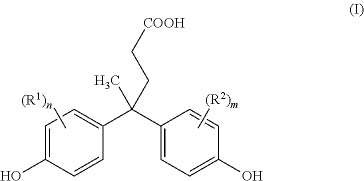

where
m and n are independently 0, 1 or 2, and
R¹ and R² are independently an alkyl, alkenyl or alkoxy radical having 1 to 10 carbon atoms, or hydroxyl, or a linear hydrocarbyl radical having 15 carbon atoms,
and optionally at least one thinner.

A “thinner” refers to a substance that is soluble in an epoxy resin and lowers its viscosity, and that is not chemically incorporated into the epoxy resin polymer during the curing process.

A “primary amino group” refers to an amino group which is bonded to a single organic radical and bears two hydrogen atoms; a “secondary amino group” refers to an amino group which is bonded to two organic radicals that may also together be part of a ring and bears one hydrogen atom; and a “tertiary amino group” refers to an amino group which is bonded to three organic radicals, two or three of which may also be part of one or more rings, and does not bear any hydrogen atom.

“Amine hydrogen” refers to the hydrogen atoms of primary and secondary amine groups.

“Amine hydrogen equivalent weight” refers to the mass of an amine or an amine-containing composition that contains one molar equivalent of amine hydrogen. It is expressed in units of “g/eq”.

“Epoxy equivalent weight” refers to the mass of an epoxy group-containing compound or composition that contains one molar equivalent of epoxy groups. It is expressed in units of “g/eq”.

Substance names beginning with “poly”, such as polyamine or polyepoxide, refer to substances that formally contain two or more of the functional groups that occur in their name per molecule.

“Molecular weight” refers to the molar mass (in grams per mole) of a molecule. “Average molecular weight” refers to the number-average Mn of a polydisperse mixture of oligomeric or polymeric molecules, which is typically determined by gel-permeation chromatography (GPC) against polystyrene as standard.

“Pot life” refers to the maximum period of time from the mixing of the components and the application of an epoxy resin composition in which the mixed composition is in a sufficiently free-flowing state and has good ability to wet the substrate surfaces.

“Gel time” refers to the time interval from mixing the components of an epoxy resin composition until the gelation thereof.

“Room temperature” refers to a temperature of 23° C.

All industry standards and norms mentioned in the document refer to the versions valid at the date of first filing, unless otherwise stated.

Percentages by weight (% by weight) refer to the proportions by mass of a constituent in a composition based on the overall composition, unless otherwise stated. The terms “mass” and “weight” are used synonymously in the present document.

The at least one room temperature liquid amine A1 is also referred to hereinafter as amine A1.

Suitable amines A1 are especially 1,5-diamino-2-methylpentane (MPMD), 2-butyl-2-ethylpentane-1,5-diamine (C11 neodiamine), hexane-1,6-diamine, 2,5-dimethylhexane-1,6-diamine, 2,2(4),4-trimethylhexane-1,6-diamine (TMD), isophoronediamine (IPDA), 1,2-, 1,3- or 1,4-diaminocyclohexane, 1,3-bis(aminomethyl)cyclohexane, 1,4-bis(aminomethyl)cyclohexane, bis(4-aminocyclohexyl)methane, bis(4-amino-3-methylcyclohexyl)methane, 2 (4)-methyl-1,3-diaminocyclohexane, 2,5(2,6)-bis(aminomethyl)bicyclo[2.2.1]heptane (NBDA), 3(4), 8(9)-bis(aminomethyl)tricyclo[5.2.1.0^{2,6}]decane, 1,4-diamino-2,2,6-trimethylcyclohexane (TMCDA), menthane-1,8-diamine, 3,9-bis(3-aminopropyl)-2,4,8,10-tetraoxaspiro[5.5]undecane, 1,3-bis(aminomethyl)benzene (MXDA), 1,4-bis(aminomethyl)benzene, diethylenetriamine (DETA), triethylenetetramine (TETA), tetraethylenepentamine (TEPA), pentaethylenehexamine (PEHA), dipropylenetriamine (DPTA), N-(2-aminoethyl)propane-1,3-diamine (N3 amine), N,N′-bis(3-aminopropyl)ethylenediamine (N4 amine), N,N′-bis(3-aminopropyl)-1,4-diaminobutane, N5-(3-aminopropyl)-2-methylpentane-1,5-diamine, N3-(3-aminopentyl) pentane-1,3-diamine, N5-(3-amino-1-ethylpropyl)-2-methylpentane-1,5-diamine, N,N′-bis(3-amino-1-ethylpropyl)-2-methylpentane-1,5-diamine, 3-(2-aminoethyl)aminopropylamine, bis(2-aminoethyl)ether, 3,6-dioxaoctane-1,8-diamine, 4,7-dioxadecane-1,10-diamine, 4,7-dioxadecane-2,9-diamine, 4,9-dioxadodecane-1,12-diamine, 5,8-dioxadodecane-3,10-diamine, 4,7,10-trioxatridecane-1,13-diamine, polyoxyalkylenedi-or-triamines, especially polyoxypropylenediamines or polyoxypropylenetriamines such as Jeffamine® D-230 (from Huntsman), 2,5-bis(aminomethyl)furan, 2,5-bis(aminomethyl)tetrahydrofuran, bis(5-aminomethylfuran-2-yl)methane, bis(5-aminomethyltetrahydrofuran-2-yl)methane, 2,2-bis(5-aminomethylfuran-2-yl)propane or 2,2-bis(5-aminomethyltetrahydrofuran-2-yl)propane.

Preferably, the amine A1 is selected from the group consisting of 1,5-diamino-2-methylpentane (MPMD), 2-butyl-2-ethylpentane-1,5-diamine (C11 neodiamine). 2,2(4), 4-trimethylhexane-1,6-diamine (TMD), isophoronediamine (IPDA), 1,2-diaminocyclohexane, 1,3-bis(aminomethyl)cyclohexane, bis(4-aminocyclohexyl)methane, bis(4-amino-3-methylcyclohexyl)methane, 2(4)-methyl-1,3-diaminocyclohexane, 2,5(2,6)-bis(aminomethyl)bicyclo[2.2.1]heptane (NBDA), 1,3-bis(aminomethyl)benzene (MXDA), 1,4-bis(aminomethyl)benzene, 2,5-bis(aminomethyl)furan, 2,5-bis(aminomethyl)tetrahydrofuran, bis(5-aminomethylfuran-2-yl)methane, bis(5-aminomethyltetrahydrofuran-2-yl)methane, 2,2-bis(5-aminomethylfuran-2-yl)propane and 2,2-bis(5-aminomethyltetrahydrofuran-2-yl)propane.

Among these, preference is given to IPDA, 1,2-diaminocyclohexane, 1,3-bis(aminomethyl)cyclohexane, 2 (4)-methyl-1,3-diaminocyclohexane or MXDA.

The most preferred amine A1 is isophoronediamine (IPDA). IPDA enables curing agents of the invention with particularly high final hardness and particularly low yellowing.

Isophoronediamine (3-aminomethyl-3,5,5-trimethylcyclohexylamine) is a cycloaliphatic primary diamine which takes the form of a mixture of cis and trans isomer and is commercially available, for example as Vestamin® IPD (from Evonik).

In a preferred embodiment of the invention, isophoronediamine has been produced from acetone from a renewable source. This enables particularly sustainable curing agents for epoxy resins.

In a preferred embodiment, the curing agent, in addition to the amine A1 isophoronediamine, contains at least one further amine A1, especially in a weight ratio of isophoronediamine to further amine A1 of 50/50 to 90/10.

In a preferred embodiment of the invention, the curing agent contains isophoronediamine and 1,3-bis(aminomethyl)benzene as amine A1, especially in a weight ratio of isophoronediamine to 1,3-bis(aminomethyl)benzene of 50/50 to 90/10, preferably 60/40 to 80/20. Such a curing agent enables particularly rapid curing coupled with high final hardness and low yellowing.

The curing agent also contains at least one diphenolic acid of the formula (I)

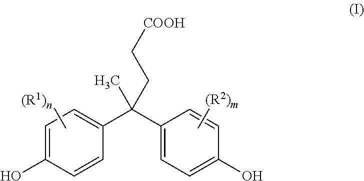

where
m and n are independently 0, 1 or 2, and
R¹ and R² are independently an alkyl, alkenyl or alkoxy radical having 1 to 10 carbon atoms, or hydroxyl, or a linear hydrocarbyl radical having 15 carbon atoms.

More preferably, m and n are both 0. This diphenolic acid is 4,4-bis(4-hydroxyphenyl)pentanoic acid. It is particularly easily obtainable and enables rapidly curing epoxy resin compositions having particularly good processibility. It is especially obtainable from the reaction of phenol with 4-oxopentanoic acid (levulinic acid).

In a preferred embodiment of the invention, m and n are both 1, and R¹ and R² are a radical selected from the group consisting of methyl, methoxy, ethyl, ethoxy, propyl, isopropyl, butyl, tert-butyl, pentyl, allyl, hydroxyl and linear aliphatic C₁₅H₂₅₋₃₁-hydrocarbyl radicals. Such diphenolic acids are obtainable in particular from the reaction of correspondingly substituted phenols with 4-oxopentanoic acid (levulinic acid).

A phenol substituted by linear aliphatic C₁₅H₂₅₋₃₁-hydrocarbyl radicals is in particular cardanol. Cardanol is a renewable raw material and is especially obtained from the shells of cashew nuts. Cardanol contains mainly a mixture of phenols 3-substituted by a linear aliphatic C₁₅H₂₅- or C₁₅H₂₇- or C₁₅H₂₉- or C₁₅H₃₁-hydrocarbyl radical.

Particularly preferred diphenolic acids of the formula (I) are selected from the group consisting of 4,4-bis(4-hydroxyphenyl)pentanoic acid, 4,4-bis(4-hydroxy-3-methylphenyl)pentanoic acid, 4,4-bis(4-hydroxy-3-ethylphenyl)pentanoic acid, 4,4-bis(4-hydroxy-3-isopropylphenyl)pentanoic acid, 4,4-bis(4-hydroxy-3-butylphenyl)pentanoic acid, 4,4-bis(4-hydroxy-3-tert-butylphenyl)pentanoic acid, 4,4-bis(4-hydroxy-3-pentylphenyl)pentanoic acid, 4,4-bis(4-hydroxy-3-allylphenyl)pentanoic acid, 4,4-bis(4-hydroxy-3,5-dimethylphenyl)pentanoic acid, 4,4-bis(4-hydroxy-3,5-diisopropylphenyl)pentanoic acid, 4,4-bis(4-hydroxy-3,5-di-tert-butylphenyl)pentanoic acid, 4,4-bis(4-hydroxy-3-methyl-5-isopropylphenyl)pentanoic acid, 4,4-bis(4-hydroxy-2-methylphenyl)pentanoic acid, 4,4-bis(4-hydroxy-2-ethylphenyl)pentanoic acid, 4,4-bis(4-hydroxy-3-methoxyphenyl)pentanoic acid, 4,4-bis(3,4-dihydroxyphenyl)pentanoic acid, 4,4-bis(2,4-dihydroxyphenyl)pentanoic acid and 4,4-bis(4-hydroxy-2-(C₁₅H₂₅₋₃₁ linear hydrocarbyl)phenyl)pentanoic acids.

Among these, preference is given to 4,4-bis(4-hydroxyphenyl)pentanoic acid, 4,4-bis(4-hydroxy-3-methylphenyl)pentanoic acid, 4,4-bis(4-hydroxy-3-allylphenyl)pentanoic acid, 4,4-bis(4-hydroxy-3-methoxyphenyl)pentanoic acid, 4,4-bis(3,4-dihydroxyphenyl)pentanoic acid or 4,4-bis(2,4-dihydroxyphenyl)pentanoic acid.

Most preferred is 4,4-bis(4-hydroxyphenyl)pentanoic acid.

Particular preference is given to the use of a diphenolic acid that has been produced at least partly from renewable raw materials. This enables particularly sustainable curing agents for epoxy resins.

The weight ratio between the diphenolic acid of the formula (I) and the amine A1 is preferably in the range from 0.025 to 0.5, especially 0.05 to 0.25. Such a curing agent is easily reproducible and of low viscosity, and enables good processibility, rapid curing and high final hardnesses.

Preferably, the curing agent, based on the overall curing agent, contains 1% to 10% by weight, preferably 2% to 8% by weight, of diphenolic acid of the formula (I).

The curing agent is preferably produced by heating an initial charge of the amine A1, especially to a temperature in the range from 40 to 80° C., especially 50 to 70° C., and then gradually adding the diphenolic acid and dissolving it with good stirring.

If the curing agent contains a thinner, the preparation is preferably effected in such a way that the initially charge of thinner or of a mixture of thinner and amine A1 is heated, especially to a temperature in the range from 40 to 80° C., especially 50 to 70° C., and then the diphenolic acid is added gradually and dissolved with good stirring.

The curing agent preferably contains at least one thinner.

Suitable thinners are especially n-propanol, isopropanol, n-butanol, isobutanol, tert-butanol, 1-pentanol, 2-pentanol, 3-pentanol, 2-methyl-1-butanol, 3-methyl-1-butanol, 3-methyl-2-butanol, n-hexanol, 2-ethylhexanol, xylene, 2-methoxyethanol, dimethoxyethanol, 2-ethoxyethanol, 2-propoxyethanol, 2-isopropoxyethanol, 2-butoxyethanol, 2-phenoxyethanol, 2-benzyloxyethanol, benzyl alcohol, ethylene glycol, ethylene glycol dimethyl ether, ethylene glycol diethyl ether, ethylene glycol dibutyl ether, ethylene glycol diphenyl ether, diethylene glycol, diethylene glycol monomethyl ether, diethylene glycol monoethyl ether, diethylene glycol mono-n-butyl ether, diethylene glycol dimethyl ether, diethylene glycol diethyl ether, diethylene glycol di-n-butyl ether, propylene glycol butyl ether, propylene glycol phenyl ether, dipropylene glycol, dipropylene glycol monomethyl ether, dipropylene glycol dimethyl ether, dipropylene glycol di-n-butyl ether, 2,2,4-trimethylpentane-1,3-diol monoisobutyrate, diphenylmethane, diisopropylnaphthalene, isopropylbiphenyls, mineral oil fractions, for example Solvesso® grades (Exxon), alkylphenols such as tert-butylphenol, nonylphenol, dodecylphenol, cardanol, styrenated phenol, liquid aromatic hydrocarbon resins, especially types containing phenol groups, alkoxylated phenol, especially ethoxylated or propoxylated phenol, adipates, sebacates, phthalates, benzoates, organic phosphoric or sulfonic esters or sulfonamides. Among these, preference is given to aromatic thinners having a boiling point of more than 200° C.

The thinner is preferably selected from the group consisting of benzyl alcohol, styrenated phenol, ethoxylated phenol such as, in particular, 2-phenoxyethanol, ethoxylated benzyl alcohol such as, in particular, 2-benzyloxyethanol, aromatic hydrocarbon resins containing phenol groups, such as, in particular, the Novares® LS 500, LX 200, LA 300 or LA 700 products (from Rütgers), diisopropylnaphthalene, isopropylbiphenyls and cardanol.

Most preferred is benzyl alcohol.

The thinner is preferably present in such an amount that the weight ratio between thinner and amine A1 is in the range from 0.15 to 1.5, especially 0.3 to 1.2. Such a curing agent enables epoxy resin coatings having a particularly low tendency to blushing effects and hence particularly attractive surfaces.

Preferably, the curing agent, based on the overall curing agent, contains 10% to 60% by weight, especially 20% to 50% by weight, of thinner.

A particularly preferred curing agent contains, based on the overall curing agent,
30% to 80% by weight of amine A1,
1% to 10% by weight, especially 2% to 8% by weight, of diphenolic acid of the formula (I), and
10% to 60% by weight, preferably 20% to 50% by weight, of thinners.

In a preferred embodiment, the curing agent contains at least one further accelerator which is not a diphenolic acid of the formula (I).

Suitable further accelerators are especially nitrates such as, in particular, calcium nitrate, phenols, especially bisphenols, phenolic resins such as, in particular, phenyl-formaldehyde resins, also called novolaks, or Mannich bases such as, in particular, 2-(dimethylaminomethyl) phenol, 2,4,6-tris(dimethylaminomethyl) phenol or polymers of phenol, formaldehyde and N,N-dimethylpropane-1,3-diamine, phosphites such as, in particular, di- or triphenyl phosphites, or compounds having mercapto groups. Preference is given to phenol-formaldehyde resins, calcium nitrate or Mannich bases.

Most preferred is 2,4,6-tris(dimethylaminomethyl) phenol.

The curing agent may contain further amines other than amine A1.

Suitable such further amines are, in particular, alkylated amines such as, in particular, N-benzylethane-1,2-diamine, N-benzylpropane-1,2-diamine, N-benzyl-1,3-bis(aminomethyl)benzene, N-(2-ethylhexyl)-1,3-bis(aminomethyl)benzene, N-furfurylethane-1,2-diamine or N-tetrahydrofurfurylethane-1,2-diamine, and also 3-dimethylaminopropylamine (DMAPA), 3-(3-(dimethylamino)propylamino)propylamine (DMAPAPA) or N-aminoethylpiperazine, higher molecular weight polyoxypropylenediamines or -triamines such as, in particular, Jeffamine® D-400 or Jeffamine® T-403 (both from Huntsman), phenalkamines or -amides, which are reaction products of cardanol with aldehydes, especially formaldehyde, and polyamines, room temperature solid amines such as, in particular, dodecane-1,12-diamine or bis(hexamethylene)triamine (BHMT), or amine-functional adducts of these amines or of the amines A1 mentioned with mono- or polyepoxides, in particular aromatic epoxy resins.

Particularly suitable further amines are selected from the group consisting of N-benzylethane-1,2-diamine, amine-functional adducts of IPDA with aromatic epoxy resins, amine-functional adducts of MXDA with aromatic epoxy resins and amine-functional adducts of N-benzylethane-1,2-diamine with aromatic epoxy resins. Preferred aromatic epoxy resins are bisphenol A diglycidyl ether or bisphenol F diglycidyl ether.

The curing agent may be water-based and contain water in the range from 15% to 90% by weight, preferably 20% to 80% by weight, based on the overall curing agent.

The curing agent is preferably not water-based. It preferably contains less than 15% by weight, especially less than 10% by weight, of water, based on the overall curing agent. Such a curing agent is particularly suitable for nonaqueous epoxy resin products.

In a preferred embodiment, the curing agent contains a small amount of water, in particular, based on the overall curing agent, 0.5% to 9% by weight, preferably 1% to 5% by weight, of water. Such curing agents enable particularly attractive surfaces.

The curing agent may contain further constituents, especially
further adducts, especially adducts of ethane-1,2-diamine or propane-1,2-diamine with cresyl glycidyl ether or aromatic epoxy resins, in which unconverted ethane-1,2-diamine or propane-1,2-diamine has been removed by distillation after the reaction,
monoamines such as, in particular, benzylamine or furfurylamine,
polyamidoamines, especially reaction products of a mono- or polybasic carboxylic acid, or the ester or anhydride thereof, especially a dimer fatty acid, with a polyamine used in stoichiometric excess, especially DETA or TETA,
Mannich bases,
aromatic polyamines such as, in particular, 4,4′-, 2,4′ and/or 2,2′-diaminodiphenylmethane, toluene-2,4(6)-diamine, 3,5-dimethylthiotoluene-2,4(6)-diamine or 3,5-diethyltolylene-2,4(6)-diamine,
compounds having mercapto groups, especially liquid mercaptan-terminated polysulfide polymers, mercaptan-terminated polyoxyalkylene ethers, mercaptan-terminated polyoxyalkylene derivatives, polyesters of thiocarboxylic acids, 2,4,6-trimercapto-1,3,5-triazine, triethylene glycol dimercaptan or ethanedithiol,
surface-active additives, especially defoamers, deaerating agents, wetting agents, dispersants or leveling agents, or
stabilizers, especially stabilizers against oxidation, heat, light or UV radiation.

The invention further provides an epoxy resin composition comprising
a resin component comprising at least one epoxy resin and
a curing agent component comprising the above-described curing agent.

A suitable epoxy resin is obtained in a known manner, especially from the reaction of epichlorohydrin with polyols, polyphenols or amines.

Suitable epoxy resins are especially aromatic epoxy resins, especially the glycidyl ethers of:
bisphenol A, bisphenol F or bisphenol A/F, where A stands for acetone and F for formaldehyde used as reactants in the production of these bisphenols. In the case of bisphenol F, positional isomers may also be present, more particularly ones derived from 2,4′- or 2,2′-hydroxyphenylmethane;
dihydroxybenzene derivatives such as resorcinol, hydroquinone or catechol;
further bisphenols or polyphenols such as bis(4-hydroxy-3-methylphenyl)methane, 2,2-bis(4-hydroxy-3-methylphenyl)propane (bisphenol C), bis(3,5-dimethyl-4-hydroxyphenyl)methane, 2,2-bis(3,5-dimethyl-4-hydroxyphenyl)propane, 2,2-bis(3,5-dibromo-4-hydroxyphenyl)propane, 2,2-bis(4-hydroxy-3-tert-butylphenyl)propane, 2,2-bis(4-hydroxyphenyl)butane (bisphenol B), 3,3-bis(4-hydroxyphenyl)pentane, 3,4-bis(4-hydroxyphenyl)hexane, 4,4-bis(4-hydroxyphenyl)heptane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane (bisphenol Z), 1,1-bis(4-hydroxyphenyl)-3,3,5-trimethylcyclohexane (bisphenol TMC), 1,1-bis(4-hydroxyphenyl)-1-phenylethane, 1,4-bis[2-(4-hydroxyphenyl)-2-propyl]benzene (bisphenol P), 1,3-bis[2-(4-hydroxyphenyl)-2-propyl]benzene (bisphenol M), 4,4′-dihydroxydiphenyl (DOD), 4,4′-dihydroxybenzophenone, bis(2-hydroxynaphth-1-yl)methane, bis(4-hydroxynaphth-1-yl)methane, 1,5-dihydroxynaphthalene, tris(4-hydroxyphenyl)methane, 1,1,2,2-tetrakis(4-hydroxyphenyl)ethane, bis(4-hydroxyphenyl) ether or bis(4-hydroxyphenyl) sulfone;
novolaks, which are especially condensation products of phenol or cresols with formaldehyde or paraformaldehyde or acetaldehyde or crotonaldehyde or isobutyraldehyde or 2-ethylhexanal or benzaldehyde or furfural;
aromatic amines such as aniline, toluidine, 4-aminophenol, 4,4′-methylenediphenyldiamine, 4,4′-methylenediphenyldi(N-methyl)amine, 4,4′-[1,4-phenylenebis(1-methylethylidene)]bisaniline (bisaniline P) or 4,4′-[1,3-phenylenebis(1-methylethylidene)]bisaniline (bisaniline M).

Further suitable epoxy resins are aliphatic or cycloaliphatic polyepoxides, especially
glycidyl ethers of saturated or unsaturated, branched or unbranched, cyclic or open-chain di-, tri- or tetrafunctional C₂ to C₃₀ alcohols, especially ethylene glycol, propylene glycol, butylene glycol, hexanediol, octanediol, polypropylene glycols, dimethylolcyclohexane, neopentyl glycol, dibromoneopentyl glycol, castor oil, trimethylolpropane, trimethylolethane, pentaerythritol, sorbitol or glycerol, or alkoxylated glycerol or alkoxylated trimethylolpropane;
a hydrogenated bisphenol A, F or A/F liquid resin or the glycidylation products of hydrogenated bisphenol A, F or A/F;
an N-glycidyl derivative of amides or heterocyclic nitrogen bases, such as triglycidyl cyanurate or triglycidyl isocyanurate, or reaction products of epichlorohydrin with hydantoin.

Further suitable epoxy resins are epoxy resins from the reaction of biobased hydroxy-functional raw materials with epichlorohydrin, especially epichlorohydrin derived from biobased glycerol. Particular preference is given to vanillin-based epoxy resins such as, in particular, diglycidyl ethers of vanillin alcohol and glycerol-based epoxy resins such as, in particular, triglycidyl ethers of biobased glycerol.

The epoxy resin is preferably a liquid resin or a mixture comprising two or more liquid epoxy resins.

“Liquid epoxy resin” refers to an industrial polyepoxide having a glass transition temperature below 25° C.

The resin component optionally additionally contains proportions of solid epoxy resin.

The epoxy resin is especially an aromatic liquid resin based on a bisphenol or novolak, especially having an average epoxy equivalent weight in the range from 156 to 210 g/eq.

A bisphenol A diglycidyl ether and/or bisphenol F diglycidyl ether is particularly suitable, as commercially available for example from Olin, Huntsman or Momentive. These liquid resins have a low viscosity for epoxy resins and provide for rapid curing and high hardnesses. They may contain proportions of solid bisphenol A resin or novolak epoxy resins.

Particular preference is also given to a bisphenol A diglycidyl ether from the reaction of bisphenol A with biobased epichlorohydrin. This enables particularly sustainable epoxy resin compositions.

Also particularly suitable are phenol-formaldehyde novolak glycidyl ethers, especially having an average functionality in the range from 2.3 to 4, preferably 2.5 to 3. These may contain proportions of other epoxy resins, in particular bisphenol A diglycidyl ether or bisphenol F diglycidyl ether.

Also particularly suitable are diglycidyl ethers of vanillin alcohol or triglycidyl ethers of glycerol, in particular diglycidyl ethers of vanillin alcohol.

More preferably, the resin component comprises at least one epoxy resin selected from the group consisting of bisphenol A diglycidyl ethers, bisphenol F diglycidyl ethers, phenol-formaldehyde novolak glycidyl ethers having an average functionality of 2.3 to 4, preferably 2.5 to 3, vanillin alcohol diglycidyl ethers, and combinations of two or more of the epoxy resins mentioned.

The resin component preferably contains at least one reactive diluent containing epoxy groups.

Suitable reactive diluents are especially butanediol diglycidyl ether, hexanediol diglycidyl ether, trimethylolpropane di- or triglycidyl ether, phenyl glycidyl ether, cresyl glycidyl ether, guaiacol glycidyl ether, 4-methoxyphenyl glycidyl ether, p-n-butylphenyl glycidyl ether, p-tert-butylphenyl glycidyl ether, 4-nonylphenyl glycidyl ether, 4-dodecylphenyl glycidyl ether, cardanol glycidyl ether, benzyl glycidyl ether, allyl glycidyl ether, butyl glycidyl ether, hexyl glycidyl ether, 2-ethylhexyl glycidyl ether, or glycidyl ethers of natural alcohols, such as in particular C₈ to C₁₀ or C₁₂ to C₁₄ or C₁₃ to C₁₅ alkyl glycidyl ethers.

The epoxy resin composition preferably contains at least one further constituent selected from surface-active additives, fillers and pigments.

Suitable surface-active additives are especially defoamers, deaerating agents, wetting agents, dispersants, leveling agents and/or dispersed paraffin waxes.

Suitable fillers are, in particular, ground or precipitated calcium carbonate, which is optionally coated with fatty acid, especially stearates, baryte (heavy spar), talc, quartz powder, quartz sand, silicon carbide, iron mica, dolomite, wollastonite, kaolin, mica (potassium aluminum silicate), molecular sieves, aluminum oxide, zinc oxide, aluminum-doped zinc oxide, aluminum hydroxide, magnesium hydroxide, silica, cement, gypsum, fly ash, carbon black, graphite, metal powders such as aluminum, copper, iron, zinc, silver or steel, PVC powder or hollow beads. Preference among these is given to calcium carbonate, baryte, quartz powder, talc, aluminum powder or a combination thereof.

Suitable pigments especially include titanium dioxides, iron oxides, chromium (III) oxides, organic pigments, carbon black or anticorrosion pigments, especially phosphates, orthophosphates or polyphosphates containing especially chromium, zinc, aluminum, calcium, strontium or a combination of these metals as counterions. Titanium dioxides are particularly suitable.

The epoxy resin composition may optionally comprise further auxiliaries and additives, especially the following:
further reactive diluents, especially epoxidized soybean oil or linseed oil, compounds containing acetoacetate groups, especially acetoacetylated polyols, butyrolactone, carbonates, aldehydes, isocyanates or silicones having reactive groups,
solvents,
polymers, especially polyamides, polysulfides, polyvinyl formal (PVF), polyvinyl butyral (PVB), polyurethanes (PUR), polymers having carboxyl groups, polyamides, butadiene-acrylonitrile copolymers, styrene-acrylonitrile copolymers, butadiene-styrene copolymers, homo- or copolymers of unsaturated monomers, especially from the group comprising ethylene, propylene, butylene, isobutylene, isoprene, vinyl acetate or alkyl (meth)acrylates, especially chlorosulfonated polyethylenes or fluorine-containing polymers or sulfonamide-modified melamines,
fibers, especially glass fibers, carbon fibers, metal fibers, ceramic fibers or polymer fibers such as polyamide fibers or polyethylene fibers,
nanofillers, especially carbon nanotubes;
rheology modifiers, especially thickeners or antisettling agents,
adhesion improvers, especially organoalkoxysilanes,
flame-retardant substances, especially the aluminum hydroxide or magnesium hydroxide fillers already mentioned, antimony trioxide, antimony pentoxide, boric acid (B(OH)₃), zinc borate, zinc phosphate, melamine borate, melamine cyanurate, ammonium polyphosphate, melamine phosphate, melamine pyrophosphate, polybrominated diphenyl oxides or diphenyl ethers, phosphates such as, in particular, diphenyl cresyl phosphate, resorcinol bis(diphenyl phosphate), resorcinol diphosphate oligomer, tetraphenylresorcinol diphosphite, ethylenediamine diphosphate, bisphenol A bis(diphenyl phosphate), tris(chloroethyl) phosphate, tris(chloropropyl) phosphate, tris(dichloroisopropyl) phosphate, tris[3-bromo-2,2-bis(bromomethyl)propyl] phosphate, tetrabromobisphenol A, bis(2,3-dibromopropyl ether) of bisphenol A, brominated epoxy resins, ethylenebis(tetrabromophthalimide), ethylenebis(dibromonorbornanedicarboximide), 1,2-bis(tribromophenoxy)ethane, tris(2,3-dibromopropyl) isocyanurate, tribromophenol, hexabromocyclododecane, bis(hexachlorocyclopentadieno)cyclooctane or chloroparaffins, or
stabilizers against oxidation, heat, light or UV radiation or biocides.

The epoxy resin composition preferably contains less than 5% by weight of water. Such a non-water-based epoxy resin composition is particularly versatile and particularly water-resistant.

The resin component and the curing agent component of the epoxy resin composition are stored in separate receptacles.

A suitable container for storage of the resin component or the curing agent component is especially a vat, a hobbock, a bag, a bucket, a can, a cartridge or a tube. The components are storable, meaning that they can be stored prior to use for several months up to one year or longer without any change in their respective properties to a degree relevant to their use.

The resin component and curing agent component are mixed shortly before or during application. The mixing ratio is preferably chosen such that the molar ratio of epoxy-reactive groups to epoxy groups is in the range from 0.5 to 1.5, especially 0.7 to 1.2. In parts by weight, the mixing ratio between the resin component and the curing agent component is typically within a range from 1:2 to 20:1.

The components are mixed continuously or in batches by means of a suitable method, taking care to ensure that not too much time elapses between the mixing of the components and the application, and that application takes place within the pot life. Mixing and application can be effected at ambient temperature, which is typically in the range from about 5 to 40° C., preferably about 10 to 35° C.

Upon mixing of the components, the curing of the epoxy resin composition by chemical reaction commences. Primary and secondary amino groups, and any further groups present that are reactive toward epoxy groups, react with the epoxy groups, resulting in ring opening thereof. As a result primarily of these reactions, the composition polymerizes and thereby cures.

Curing typically extends over a few hours to days. The duration depends upon factors including temperature, reactivity of the constituents, stoichiometry thereof, type and amount of the diphenolic acid of the formula (I) and any further amines and/or accelerators present.

In the freshly mixed state the epoxy resin composition has a low viscosity. The viscosity 5 minutes after mixing of the resin component and the curing agent component at 20° C. is preferably in the range from 0.1 to 10 Pa·s, preferably 0.2 to 5 Pa·s, more preferably 0.3 to 2 Pa·s, measured using a cone-plate viscometer at a shear rate of 10 s⁻¹.

The epoxy resin composition is preferably applied to at least one substrate.

Suitable substrates are especially:
glass, glass ceramic, concrete, mortar, cement screed, fiber cement, brick, tile, plaster or natural rocks such as granite or marble;
repair compounds or leveling compounds based on PCC (polymer-modified cement mortar) or ECC (epoxy resin-modified cement mortar);
metals or alloys such as aluminum, iron, steel, copper, other nonferrous metals, including surface-finished metals or alloys such as galvanized or chrome-plated metals;
asphalt or bitumen;
leather, textiles, paper, wood, wood-based materials bonded with resins, for example phenolic, melamine or epoxy resins, resin-textile composites or further polymer composites;
plastics, such as rigid and flexible PVC, polycarbonate, polystyrene, polyester, polyamide, PMMA, ABS, SAN, epoxy resins, phenolic resins, PUR, POM, TPO, PE, PP, EPM or EPDM, in each case untreated or surface-treated, for example by means of plasma, corona or flames;
fiber-reinforced plastics, such as carbon fiber-reinforced plastics (CFRP), glass fiber-reinforced plastics (GFRP), and sheet molding compounds (SMC);
insulation foams, especially made of EPS, XPS, PUR, PIR, rock wool, glass wool or foamed glass;
coated or painted substrates, especially painted tiles, coated concrete, powder-coated metals or alloys or painted metal sheets;
coatings, paints or varnishes, especially coated floors that have been overcoated with a further floor covering layer.

The substrates can if required be pretreated prior to application, especially by physical and/or chemical cleaning methods or the application of an activator or a primer.

The substrates are especially coated and/or adhesively bonded.

The invention further provides a cured composition obtained from the epoxy resin composition described after mixing of the resin component and the curing agent component.

The composition is preferably used as coating, primer, adhesive, sealant, potting compound, casting resin or impregnating resin. The composition is more preferably used as coating.

The use gives rise to an article containing the cured composition composed of the epoxy resin composition described.

The article is in particular a floor coating, wall coating, component coating, pipe coating, roof coating or an anticorrosion coating, or an adhesive-bonded article.

### EXAMPLES

Working examples are adduced hereinafter, which are intended to further elucidate the invention described. The invention is of course not limited to these described working examples.
“AHEW” stands for amine hydrogen equivalent weight.
“EEW” stands for epoxy equivalent weight.
“Standard climatic conditions” (“SCC”) refers to a temperature of 23±1° C. and a relative air humidity of 50±5%.

The chemicals used were from Sigma-Aldrich Chemie GmbH, unless stated otherwise.

### Substances and Abbreviations Used

| | |
|---|---|
| Araldite ® | bisphenol A diglycidyl ether, EEW about 187 g/eq |
| GY 250 | (Huntsman) |
| Araldite ® | monoglycidyl ethers of C₁₂ to C₁₄ alcohols, |
| DY-E | EEW about 290 g/eq (Huntsman) |
| IPDA | 3-aminomethyl-3,5,5-trimethylcyclohexylamine, |
| | AHEW 42.6 g/eq (Vestamin ® IPD, Evonik) |
| MXDA | 1,3-bis(aminomethyl)benzene, AHEW 34 g/eq |
| | (Mitsubishi Gas Chemical) |
| BAC | 1,3-bis(aminomethyl)cyclohexane, AHEW 35.5 g/eq |
| | (from Mitsubishi Gas Chemical) |
| TMD | 2,2(4),4-trimethylhexane-1,6-diamine, AHEW 39.6 |
| | g/equiv. (Vestamin ® TMD from Evonik) |
| Diphenolic | 4,4-bis(4-hydroxyphenyl)pentanoic acid |
| acid-1 | |
| K54 | 2,4,6-tris(dimethylaminomethyl)phenol (Ancamine ® |
| | K54, from Evonik) |

### Production of Curing Agents for Epoxy Resins:

Curing agents H-1 to H-13:

For each curing agent, an initial charge of the amount (in parts by weight) of benzyl alcohol specified in table 1 was heated to 60° C., and the specified amount of diphenolic acid—or salicylic acid in the case of curing agent H-12 (Ref.)—was dissolved therein with good stirring. Then the solution was cooled down, and the further ingredients specified in table 1 were added in the specified amounts and mixed well, and the curing agent was stored with exclusion of moisture. For the curing agent H-13 (Ref.), the amounts of IPDA and benzyl alcohol stated in table 1 were mixed at room temperature, and the curing agent was stored with exclusion of moisture.

For each curing agent, viscosity was measured at 20° C. on a thermostatic Rheotec RC30 cone-plate viscometer (cone diameter 50 mm, cone angle 1°, cone tip-plate distance 0.05 mm, shear rate 10 s⁻¹), and the appearance of the curing agent was assessed visually.

The curing agents labeled “(Ref.)” in table 1 are noninventive comparative examples.

TABLE 1
Composition and properties of curing agents H-1 to H-13.

| Curing agent | H-1 | H-2 | H-3 | H-4 | H-5 | H-6 | H-7 |
|---|---|---|---|---|---|---|---|
| IPDA | 54.9 | 42.4 | 42.15 | — | — | — | 54.9 |
| MXDA | — | 11.25 | — | 49.3 | — | — | — |
| BAC | — | — | 11.7 | — | 50.35 | — | — |
| TMD | — | — | — | — | — | 53.1 | — |
| Diphenolic acid-1 | 3.2 | 3.3 | 3.3 | 3.6 | 3.55 | 3.35 | 3.2 |
| Salicylic acid | — | — | — | — | — | — | — |
| Benzyl alcohol | 38.7 | 39.75 | 39.55 | 43.5 | 42.55 | 40.2 | 38.7 |
| Water | 3.2 | 3.3 | 3.3 | 3.6 | 3.55 | 3.35 | — |
| K54 | — | — | — | — | — | — | 3.2 |
| Viscosity (20° C.) | 65 | 50 | 54 | 33 | 23 | 22 | 61 |
| [mPa · s] | | | | | | | |
| Appearance | clear, | clear, | clear, | clear, | clear, | clear, | clear, |
| | yellowish | yellowish | yellowish | yellowish | yellowish | yellowish | yellowish |
| AHEW [eq/g] | 77.6 | 75.5 | 75.9 | 69.0 | 70.5 | 74.6 | 77.6 |

| | | | | | H-12 | H-13 |
|---|---|---|---|---|---|---|
| Curing agent | H-8 | H-9 | H-10 | H-11 | (Ref.) | (Ref.) |
| IPDA | 50.0 | 50.0 | 50.0 | 50.0 | 50.0 | 53.2 |
| MXDA | — | — | — | — | — | — |
| BAC | — | — | — | — | — | — |
| TMD | — | — | — | — | — | — |
| Diphenolic acid-1 | 2.9 | 6.0 | 8.8 | 11.7 | — | — |
| Salicylic acid | — | — | — | — | 6.0 | — |
| Benzyl alcohol | 47.1 | 44.0 | 41.2 | 38.3 | 44.0 | 46.8 |
| Water | — | — | — | — | — | — |
| K54 | — | — | — | — | — | — |
| Viscosity (20° C.) | 50 | 92 | 209 | 532 | 76 | 27 |
| [mPa · s] | | | | | | |
| Appearance | clear, | clear, | clear, | clear, | clear, | clear, |
| | yellowish | yellowish | yellowish | yellowish | yellowish | yellowish |
| AHEW [eq/g] | 85.2 | 85.2 | 85.2 | 85.2 | 85.2 | 80.1 |

### Production of Epoxy Resin Compositions

### Compositions Z-1 to Z-13:

For each composition, the ingredients of the resin component reported in tables 2 and 3 were mixed in the specified amounts (in parts by weight) using a centrifugal mixer (SpeedMixer™ DAC 150, FlackTek Inc.) and stored with exclusion of moisture.

Subsequently, the curing agents specified in tables 2 and 3, in the respectively specified amounts (in parts by weight), were mixed with the resin component using the centrifugal mixer, and the mixed composition was immediately tested as follows: Viscosity (5′) was measured 5 min after the resin component and the curing agent had been mixed at a temperature of 20° C. with a thermostatic Rheotec RC30 cone-plate viscometer (cone diameter 50 mm, cone angle 1°, cone tip-plate distance 0.05 mm, shear rate 10 s⁻¹).

Gel time was determined by moving a freshly mixed amount of about 3 g under standard climatic conditions with a spatula at regular intervals until the mass underwent gelation.

Shore D hardness was determined in accordance with DIN 53505 on two cylindrical test specimens (diameter 20 mm, thickness 5 mm), one of which was stored under standard climatic conditions and the other at 8° C. and 80% relative humidity, and the hardness was measured in each case after 1 day (24 h), after 2 days and in some cases also after 3 days.

In addition, a film was applied to a glass plate in a layer thickness of 500 μm, and this was stored/cured under standard climatic conditions. König's hardness (König's pendulum hardness to DIN EN ISO 1522) was determined on this film after 1 day, 2 days, 7 days and 14 days (1d SCC), (2d SCC), (7d SCC), (14d SCC). After 14 days, the appearance (SCC) of the film was assessed. A clear film was described as “attractive” if it had a glossy and nontacky surface with no structure. “Structure” referred to any kind of marking or pattern on the surface.

A further film was applied to a glass plate in a layer thickness of 500 μm and, immediately after application, stored/cured at 8° C. and 80% relative humidity for 7 days and then under standard climatic conditions for 2 weeks. 24 hours after application, a polypropylene bottletop beneath which a moist sponge had been positioned was placed on the film. After a further 24 hours, the sponge and the bottletop were removed and positioned at a new point on the film, from which they were in turn removed and repositioned after 24 hours, which was done 4 times in total. The appearance of this film was then assessed (designated “Appearance (8°/80%)” in the tables) in the same way as described for Appearance (SCC). Also reported in each case here was the number and nature of visible marks that had formed in the film as a result of the damp sponge or the bottletop on top. The number of white discolored spots was reported as “blushing”. “None” denoted a surface without white discolored spots. “1” denoted a distinctly white discoloured spot, and “(1)” a slightly white discolored spot. “Ring” was used to state how many ring-shaped impressions were present as a result of indentation of the bottletop placed on. “1” denoted a distinct impression and “(1)” a slight impression by the bottletop. (A ring-shaped impression indicates that the coating was not yet ready to be walked on.) König's hardness was again determined on the films thus cured, in each case after 7 days at 8° C. and 80% relative humidity (König's hardness (7d 8°/80%)) and then after a further 2 days under SCC (König's hardness (+2d SCC)), 7 days under SCC (König's hardness (+7d SCC)), and 14 days under SCC (König's hardness (+14d SCC)).

As a measure of yellowing, the change in color after stressing in a weathering tester was also determined. For this purpose, a further film was applied to a glass plate in a layer thickness of 500 μm and this was stored/cured under standard climatic conditions for 2 weeks and then stressed for 72 hours at a temperature of 65° C. in a Q-Sun Xenon Xe-1 weathering tester having a Q-SUN Daylight-Q optical filter and a xenon lamp having a light intensity of 0.51 W/m² at 340 nm (Q-Sun (72 h)). The color difference ΔE of the stressed film versus the corresponding unstressed film was then determined using an NH310 colorimeter from Shenzen 3NH Technology Co. LTD equipped with silicon photoelectric diode detector, light source A, color space measurement interface CIE L*a*b*C*H*. ΔE values of more than 10 represent distinct yellowing.

The results are reported in Tables 2 and 3.

The compositions labeled “(Ref.)” are noninventive comparative examples.

TABLE 2
Composition and properties of Z-1 to Z-7.

| Composition | Z-1 | Z-2 | Z-3 | Z-4 | Z-5 | Z-6 | Z-7 |
|---|---|---|---|---|---|---|---|
| Resin component: | | | | | | | |
| Araldite ® GY-250 | 167.2 | 167.2 | 167.2 | 167.2 | 167.2 | 167.2 | 167.2 |
| Araldite ® DY-E | 31.8 | 31.8 | 31.8 | 31.8 | 31.8 | 31.8 | 31.8 |

| | H-1 | H-2 | H-3 | H-4 | H-5 | H-6 | H-7 |
|---|---|---|---|---|---|---|---|
| Curing agent: | 77.6 | 75.5 | 75.9 | 69.0 | 70.5 | 74.6 | 77.6 |
| Viscosity (5′) [mPa · s] | 0.63 | 0.58 | 0.62 | 0.44 | 0.77 | 0.54 | 0.66 |
| Gel time (h:min) | 4 h | 3:15 | 3:15 | 2:25 | 1:45 | 2:40 | >3 h |
| Shore D | | | | | | | |
| (1 d SCC) | 63 | 60 | 67 | 72 | 75 | 40 | 71 |
| (2 d SCC) | 75 | 70 | 76 | 73 | 77 | 53 | 79 |
| Shore D | | | | | | | |
| (1 d 8°/80%) | n.m.¹ | 20 | 13 | 62 | 65 | 28 | n.m.¹ |
| (2 d 8°/80%) | 58 | 67 | 64 | 74 | 72 | 58 | 57 |
| (3 d 8°/80%) | 70 | 68 | n.d. | n.d. | n.d. | n.d. | 68 |
| König's hardness [s] | | | | | | | |
| (1 d S [symbol] | 48 | 55 | 41 | 21 | 25 | 7 | 53 |
| (2 d SCC) | 104 | 112 | 88 | 28 | 39 | 13 | 112 |
| (7 d SCC) | 150 | 161 | 126 | 48 | 43 | 62 | 150 |
| (14 d SCC) | 157 | 165 | 140 | 48 | 53 | 112 | 160 |
| Appearance (SCC) | attractive | attractive | attractive | attractive | attractive | attractive | attractive |
| Q-Sun (72 h) ΔE | 5.6 | 5.5 | 5.1 | 12.0 | 10.1 | 9.6 | 14.9 |
| König's hardness [s] | | | | | | | |
| (7 d 8 [symbol] | 36 | 34 | 21 | 7 | 11 | 7 | 50 |
| (+2 d SCC) | 115 | 92 | 45 | 7 | 13 | 24 | 95 |
| (+7 d SCC) | 126 | 112 | 52 | 8 | 15 | 50 | 113 |
| (+14 d SCC) | 135 | 121 | 62 | 10 | 15 | 99 | 122 |
| Appearance (8°/80%) | attractive | attractive | attractive | hazy | attractive | hazy | attractive |
| Blushing | (1) | (1) | 1 | 4 | 2 | 1 | (1) |
| Ring | 1 | (1) | 1 | none | none | (1) | 1 |

¹not measurable (too soft)
“n.d.” stands for “not determined” [symbol]
indicates data missing or illegible when filed

TABLE 3
Composition and properties of Z-8 to Z-13.

| | | | | | Z-12 | Z-13 |
|---|---|---|---|---|---|---|
| Composition | Z-8 | Z-9 | Z-10 | Z-11 | (Ref.) | (Ref.) |
| Resin component: | | | | | | |
| Araldite ® GY-250 | 167.2 | 167.2 | 167.2 | 167.2 | 167.2 | 167.2 |
| Araldite ® DY-E | 31.8 | 31.8 | 31.8 | 31.8 | 31.8 | 31.8 |

| | H-8 | H-9 | H-10 | H-11 | H-12 | H-13 |
|---|---|---|---|---|---|---|
| Curing agent: | 85.2 | 85.2 | 85.2 | 85.2 | 85.2 | 80.1 |
| Viscosity (5′) [mPa · s] | 0.55 | 0.95 | 1.41 | 2.66 | 0.55 | 0.26 |
| Gel time (h:min) | 3:30 | 3:00 | >1:45 | >1:45 | 4:10 | >4:00 |
| Shore D | | | | | | |
| (1 d SCC) | 49 | 57 | 50 | 54 | 44 | 30 |
| (2 d SCC) | 67 | 71 | 70 | 66 | 61 | 60 |
| Shore D | | | | | | |
| (1 d 8°/80%) | n.m.¹ | n.m.¹ | n.m.¹ | n.m.¹ | n.m.¹ | n.m.¹ |
| (2 d 8°/80%) | 41 | 47 | 40 | 48 | 39 | 6 |
| (3 d 8°/80%) | 62 | 64 | 61 | 67 | 45 | 44 |
| König's hardness [s] | | | | | | |
| (1 d S [symbol] | 22 | 25 | 24 | 27 | 13 | 11 |
| (2 d SCC) | 88 | 86 | 126 | 88 | 53 | 60 |
| (7 d SCC) | 151 | 137 | 130 | 115 | 125 | 130 |
| (14 d SCC) | 160 | 154 | 134 | 118 | 132 | 132 |
| Appearance (SCC) | attractive | attractive | attractive | attractive | attractive | attractive |
| Q-Sun (72 h) ΔE | 4.7 | 4.8 | 6.0 | 6.3 | 16.1 | 7.5 |
| König's hardness [s] | | | | | | |
| (7 d 8 [symbol] ) | 37 | 36 | 29 | 28 | 24 | 21 |
| (+2 d SCC) | 101 | 98 | 88 | 70 | 69 | 84 |
| (+7 d SCC) | 127 | 125 | 90 | 84 | 113 | 120 |
| (+14 d SCC) | 139 | 136 | 99 | 95 | 125 | 133 |
| Appearance (8°/80%) | attractive | attractive | attractive | attractive | attractive | attractive |
| Blushing | (1) | (1) | (1) | 1 | (1) | (1) |
| Ring | 1 | 1 | 1 | 1 | 1 | 1 |

¹not measurable (too soft) [symbol]
indicates data missing or illegible when filed

1. A curing agent for epoxy resins, comprising
at least one room temperature liquid amine A1 having 6 to 15 carbon atoms and two primary amino groups,
at least one diphenolic acid of the formula (I) 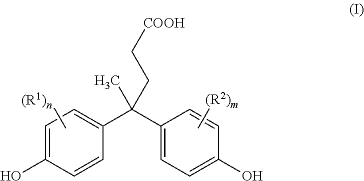
where
m and n are independently 0, 1 or 2, and
R¹ and R² are independently an alkyl, alkenyl or alkoxy radical having 1 to 10 carbon atoms, or hydroxyl, or a linear hydrocarbyl radical having 15 carbon atoms,
and optionally at least one thinner.

2. The curing agent as claimed in claim 1, wherein the amine A1 is selected from the group consisting of 1,5-diamino-2-methylpentane, 2-butyl-2-ethylpentane-1,5-diamine, 2,2(4),4-trimethylhexane-1,6-diamine, isophoronediamine, 1,2-diaminocyclohexane, 1,3-bis(aminomethyl)cyclohexane, bis(4-aminocyclohexyl)methane, bis(4-amino-3-methylcyclohexyl)methane, 2(4)-methyl-1,3-diaminocyclohexane, 2,5(2,6)-bis(aminomethyl)bicyclo[2.2.1]heptane, 1,3-bis(aminomethyl)benzene, 1,4-bis(aminomethyl)benzene, 2,5-bis(aminomethyl)furan, 2,5-bis(aminomethyl)tetrahydrofuran, bis(5-aminomethylfuran-2-yl)methane, bis(5-aminomethyltetrahydrofuran-2-yl)methane, 2,2-bis(5-aminomethylfuran-2-yl)propane and 2,2-bis(5-aminomethyltetrahydrofuran-2-yl)propane.

3. The curing agent as claimed in claim 1, wherein isophoronediamine is present as amine A1.

4. The curing agent as claimed in claim 1, wherein isophoronediamine and 1,3-bis(aminomethyl)benzene are present as amine A1.

5. The curing agent as claimed in claim 1, wherein m and n are both 0.

6. The curing agent as claimed in claim 1, wherein m and n are both 1, and R¹ and R² are a radical selected from the group consisting of methyl, methoxy, ethyl, ethoxy, propyl, isopropyl, butyl, tert-butyl, pentyl, allyl, hydroxyl and linear aliphatic C₁₅H₂₅₋₃₁-hydrocarbyl radicals.

7. The curing agent as claimed in claim 1, wherein the weight ratio between the diphenolic acid of the formula (I) and the amine A1 is in the range from 0.025 to 0.5.

8. The curing agent as claimed in claim 1, wherein at least one thinner is present.

9. The curing agent as claimed in claim 8, wherein the weight ratio between the thinner and the amine A1 is in the range from 0.15 to 1.5.

10. The curing agent as claimed in claim 8, wherein the curing agent as a whole includes
30% to 80% by weight of amine A1,
1% to 10% by weight of diphenolic acid of the formula (I), and
10% to 60% by weight of thinner.

11. The curing agent as claimed in claim 1, wherein the curing agent as a whole includes 0.5% to 9% by weight of water.

12. An epoxy resin composition comprising
a resin component comprising at least one epoxy resin and
a curing agent component comprising the curing agent as claimed in claim 1.

13. The epoxy resin composition as claimed in claim 11, wherein at least one further constituent is selected from surface-active additives, fillers and pigments.

14. A cured composition obtained from the epoxy resin composition as claimed in claim 11 after the resin component and the curing agent component have been mixed.

15. A coating, primer, adhesive, sealant, potting compound, casting resin or impregnating resin comprising the epoxy resin composition of claim 12.
